(19) United States
(12) Patent Application Publication
(10) Pub. No.: US 2004/0195744 A1
(43) Pub. Date: Oct. 7, 2004

(54) Fiber-reinforced composite springs

(75) Inventors: Erol Sancaktar, Tallmadge, OH (US); Sunil Gowrishankar, Akron, OH (US)

Correspondence Address: Roetzel & Andress, 222 South Main Street, Akron, OH, 44308, US

(73) Assignee: The University of Akron

(21) Appl. No.: 10/821,769

(22) Filed: Apr. 9, 2004

Related U.S. Application Data
(63) Continuation of application No. 09/871,755, filed on Jun. 1, 2001.

(51) Int. Cl. G02B 6/44

(52) U.S. Cl. 267/166

(57) ABSTRACT

A fiber-reinforced composite spring including a spring wire that includes a core having a plurality of fiber tows that are twisted about a longitudinal axis to create a contoured core surface, and an outer layer of resin that is substantially devoid of said fiber tows, wherein said outer layer has a thickness that varies along the longitudinal axis to form a generally uniform outer surface about the core.

### TECHNICAL FIELD

This invention relates to fiber-reinforced composite springs and methods for making the same.

### BACKGROUND OF THE INVENTION

Conventional composite springs posses properties that are influenced by the methods of their manufacture. Traditionally, composite springs have been made by saturating a twisted bundle of fiber yarns, such as glass or carbon yarns, with a suitable resin by submerging the fibers in a liquid bath of the resin, thereby forming a core wire. To enhance saturation of the fibers with resin, the submergence of the fibers in the resin may be performed in a superatmospheric-pressure chamber. The elevated pressures in the chamber force the liquid resin into all of the voids between the fibers. Once the desired degree of saturation has been achieved, the saturated fibers are removed from the saturation chamber and are drained to remove excess resin. The drained fibers are then pulled through a sheath which may be fabricated of any suitable, flexible material. Examples of these flexible materials include nylon, polyvinyl plastic, rubber and Teflon. The saturated fibers, as well as any residual resin are confined with the sheath. Such methods for forming composite springs optionally also include a step in which the encased fibers are subjected to an external pressure. The external pressure is applied to the outer surface of the sheath and produces compaction of the fibers and resin to increase the ratio of fibers to binder.

Once the core wire has been prepared as set forth above, it is wound around a mandrel to shape the core wire into the desired spring shape. While on the mandrel, the encased core wire is exposed to thermal energy, thereby curing the resin. Once curing is complete, the core wire is released from the mandrel and the sheath is removed. Such conventional processes result in the formation of a spring that has an outer surface that resembles contours of the twisted fibers. Thus, the contours of the fiber bundle are visible even after the formation of the helical spring. Due to the contoured outer surface, the spring will not exhibit predictable properties or deformation corresponding to a linear spring constant. As a result, the contoured surface may cause non-uniform compression of the spring under load. Processes such as those described above are laborious and often lead to non-uniform properties along the length of the spring.

One source the non-uniform properties is the smearing of the liquefied resin as the saturated fibers are inserted into the sheath. This can lead to the introduction of impurities into the liquefied resin as well as the creation of locations on the spring having an undesirable thickness of resin outside of the saturated fibers. In certain circumstances, smearing of the liquid resin while the fibers are being inserted into the sheath can result in portions where the fibers themselves are exposed through the resin.

According to the conventional processes for forming a composite spring, the flexible sheath confines the resin and the fibers to retain its saturated condition and shape. In this manner, the flexible sheath also permits handling of the saturated fibers without the operator being subjected to contamination or reaction to the resin. Thus, the internal diameter of the flexible sheath ultimately determines the thickness of the resin layer around the saturated fibers.

An example of a spring created by a conventional method can be found in U.S. Pat. No. 4,991,827 to Taylor. Such conventional springs generally include a core formed from a plurality of strands of monfilaments that are twisted or braided together. When twisted or braided, the outer surface of the core is contoured due to the arrangement of the strands. The core is then submerged in a suitable binder and the excess binder drained, resulting in an unshaped spring wire as shown in FIG. 3 of Taylor. An alternate arrangement of the saturated spring wire is also shown in FIGS. 9 and 10, wherein the saturated spring wire is partially concealed by a winding wrapped around the spring wire. In each of these embodiments, it is noted that the outer surface of the spring wire exhibits the underlying contours of the twisted or braided rope core, forming portions along the longitudinal axis of the spring wire having a varying diameter. These variations in the diameter of the spring wire cause the resulting spring to have varying properties in response to being subjected to a compressive load.

Accordingly, there is a need in the art for a fiber reinforced composite spring having a generally uniform outer surface with, for example, cylindrical wire shape, which does not exhibit the contours of the underlying fiber. The fiber reinforced composite spring should be fabricated from a process that minimizes the formation of imperfections that alter the physical properties of the spring. The fabrication process should also permit fine control of the thickness of the resin layer outside of the saturated fibers.

### SUMMARY OF INVENTION

In accordance with one aspect, the present invention provides a fiber-reinforced composite spring comprising a spring wire including a core that includes a plurality of fiber tows twisted about a longitudinal axis to create a contoured core surface; and an outer layer of resin that is substantially devoid of said fiber tows, wherein said outer layer has a thickness that varies along the longitudinal axis to form a generally uniform outer surface about the core, said outer surface having a cylindrical shape spring wire, for example.

In accordance with another aspect, the present invention includes a fiber-reinforced composite spring formed by a process comprising the steps of impregnating a plurality of fiber tows with a resin, encasing at least a portion of said core within a cavity having desired interior dimensions, controlling a thickness of an outer layer formed by removing a portion of said resin from said impregnated fiber tows by twisting said core within the cavity to form a spring wire, and shaping said spring wire to form a spring.

In accordance with yet another aspect, the present invention includes a method forming a fiber-reinforced composite spring, the method comprising the steps of forming a spring wire according to a method comprising the steps of impregnating a plurality of fiber tows with a resin to form a core, encasing at least a portion of said core within a cavity having suitable interior dimensions, and forming an outer layer of resin having a variable thickness along a longitudinal axis to form a generally uniform outer surface by twisting said core within said cavity to remove a portion of said resin from said core; and shaping said spring wire into a spring.

In accordance with yet another aspect, the present invention includes a method for forming a fiber-reinforced composite spring, the method comprising the steps of forming a spring wire according to a method including the steps of impregnating a core comprising a plurality of fiber tows with a resin, encasing at least a portion of said core within a flexible shroud having suitable interior dimensions, forming an outer layer of resin with a generally uniform outer surface, and controlling thickness of said uniform outer layer by twisting said core of fiber tows within the shroud to remove a desired amount of resin from the core to form said generally uniform outer surface; the method for forming said spring further comprising the step of shaping the cylindrically shaped spring wire into a spring.

Advantageously, the fiber-reinforced composite springs of this invention can have circular or non-circular wire cross-sections, and they exhibit predictable load versus deformation behavior. Also, they exhibit increased fatigue life due to the absence of any surface irregularities. Also, the process of this invention advantageously allows one to produce composite springs that have a smooth surface, which is comprised of a continuous polymer layer having a desired thickness.

### BRIEF DESCRIPTION OF THE DRAWINGS

FIG. 1 is an elevational view of a fiber-reinforced composite spring with a cylindrical wire according to this invention.

FIG. 2 is a cross-sectional view of a cylindrical spring wire according to this invention.

FIG. 3 is a cross-sectional view of an embodiment of this invention where the spring wire is a rectangular parallelopiped.

FIG. 4 includes four separate embodiments of this invention wherein the composite spring can be constructed with a variable pitch-variable shape (A), a barrel shape (B), an hourglass shape (C), and a conical shape (D).

FIG. 5 includes perspective views of two embodiments of the present invention that include fiber-reinforced composite helical tension springs of cylindrical wire that include a half-loop end (A), or a reduced diameter end coil (B).

FIG. 6 is an elevational view of a cylindrical shroud wrapped around a conical mandrel wherein the shroud includes fiber yarns and resin according to this invention.

FIG. 7 is a sectional view of a spring wire in accordance with an embodiment of the present invention, the sectional view being taken along a central axis of the spring wire.

### PREFERRED EMBODIMENT FOR CARRYING OUT THE INVENTION

The fiber-reinforced composite spring 10 according to an illustrative embodiment of this invention is shown in FIG. 1. Spring 10 includes a coiled spring wire 20, which is coiled at a helix angle 21. A cross-section of spring wire 20 according to illustrative embodiments of the present invention is shown in FIGS. 2 and 3, where fiber-reinforced core 25 and an outer layer 35 are shown.

With reference to FIG. 1, spring 20 has a coil diameter 11 and a length 12. Both coil diameter 11 and length 12 can vary based upon the desired application. Likewise, helix angle 21 can vary based upon the desired application. Varying helix angle 21 within the same spring will result in a variable rate spring as shown in FIG. 4A. Variable rate springs, such as that shown in FIG. 4A, include portions that will deform at different rates when the spring 10 is subjected to a load.

In addition to the helix angle 21, coil diameter 11 can also vary along the longitudinal axis 13 of the spring 10. For example, if the coil diameter decreases towards both ends of the spring, a barrel will be formed as shown in FIG. 4B. If the coil diameter increases towards both ends of the spring, an hourglass spring will be formed as shown in FIG. 4G. If the coil diameter increases toward one end of the spring, a conical spring will be formed as shown in FIG. 4D. If an end hook is added as shown in FIGS. 5A and 5B, the spring can be used in tension.

The cross-sectional shape of spring wire 20 may also vary, with circular, rectangular, and square cross-sections being the most commonly used, however, other cross-sectional shapes, such as elliptical, oblong, triangular, polyhedral, for example, are also included within the scope of the present invention. Some of these exemplary cross-sectional shapes are also illustrated in the figures. In one embodiment, as shown in FIG. 2, the cross-sectional shape of spring wire 20 is circular. In another embodiment, as shown in FIG. 3, the cross-sectional shape of spring wire 20 is rectangular. Again, these illustrations are merely two examples of the myriad of different shapes that fall within the scope of the present invention.

As shown in the embodiments illustrated in FIGS. 2 and 3, the spring wire 20 includes a fiber-reinforcing core 25 comprising a plurality of fiber tows 26 that are bundled together. Each fiber tow 26 includes a plurality of individual filaments 27 that are bundled together or otherwise formed into a strand. The number of individual filaments 27 within a tow 26 is typically quantified by using a “K” value, which refers to 1,000 individual filaments 27. For example, 46K refers to a fiber tow 26 having 46,000 individual filaments 27. One illustrative method of forming the fiber tows 26 from the filaments 27 includes using an adhesive, resin, and the like to bind the filaments 27 in a fixed relationship relative to each other; winding, braiding, or otherwise intertwining the filaments 27; and inserting the filaments 27 through an interior passage defined by a sleeve, a plurality of straps or loops, a winding for encircling the bundled filaments 27, or any combination thereof to maintain the strand-like shape of the tows 26. Other methods can also be employed to form the fiber tows 26 without departing from the scope of the present invention. Further, the fiber tows 26 can alternatively comprise a single individual strand (not shown) of a material, the strand having a diameter comparable to that of the fiber tows 26 formed from the bundled filaments 27.

Useful filaments 27 that can be used in the formation of the fiber tows 26 include both natural and synthetic filaments. Natural filaments may include, but are not limited to, jute and rayon of a cellulosic origin. Inorganic type filaments may include, but are not limited to, glass, carbon, boron, silicon carbide, aluminum oxide, quartz, alumina-silica, alumina-boria-silica, zirconia-silica, and fused silica fibers. Organic-type filaments may include, but are not limited to, polyamide filaments including aromatic aramids such as Kevlar™, nylon, polyester, ultra-high molecular weight polyethylene, and polybenzimidazole. Metallic filaments may include, but are not limited to, steel, aluminum, nickel, silver, and gold. The fiber tows 26 may include any combination of the above filaments, as well as any other filament. The Fiber tows 26 described above can be purchased from vendors such as Owens Corning and Zoltek, of Toledo, Ohio, and St. Louis, Missouri.

The core 25 of the illustrative embodiment may further include a resin matrix 28 to bond the fiber tows 26. The resin matrix 28 can be formed by impregnating the plurality of fiber tows 26 with a resin, as described in detail below.

Best shown in FIGS. 6 and 7, the plurality of fiber tows 26 are assembled into a generally cylindrically shaped bundle and twisted about longitudinal axis 22 of the coiled spring wire 20. Likewise, the filaments 27 within each fiber tow 26 are optionally intertwined with each other, or otherwise twisted about a longitudinal axis (not shown) that extends from each of the tows 37 in a direction generally parallel to the longitudinal axis 22.

The resin matrix 28 is typically formed by impregnating bundles 26 with a resin. The resin matrix 28 comprises a thermosetting resin, a thermoplastic resin, or any combination thereof. The resin may also include other additives such as rubber tougheners, natural layered silicates (smectites) including montmorillonite and hectorite, carbon, chopped fibers, and the like. Useful resins include epoxy, bis-maleimide, polyimide, polyester, and vinyl ester resins, as well as polyether, ether ketone, polyphenylene sulfide, polyetherimide, and polyamide imide resins. Useful thermoplastic resins include those that can be dissolved in a solvent that allows them to impregnate the yarn bundles.

The outer layer 35 typically comprises the same resin as resin matrix 28, but can comprise a resin other than that used to form the resin matrix 28. Similar to the resin matrix 28, the outer layer 35 may comprise thermosetting or thermoplastic resins, or any combination thereof. The outer layer 35, however, is substantially devoid of any portion of the fiber tows 26 and filaments 27 that, together, form the core 25. As a result, spring element 20 has a generally uniform outer surface 23.

As used herein, generally uniform outer surface 23 of the spring wire 20 refers to a surface 23 that minimally exhibits underlying contours of the core 25. A thickness d (FIG. 7) of the outer layer 35 can vary in the axial direction along the axis 22, as well as in an angular direction 0 (FIGS. 2, 3 and 7) about the axis 22 to form the generally uniform outer surface 23. As a result of the generally uniform outer surface 23, there will be a minimal number of ridges or patterns formed on the generally uniform outer surface 23 of the spring wire 20. A method of forming the generally uniform outer surface 23 is set forth in detail below.

Preferably, the outer layer 35 of spring wire 20 has a thickness that varies to account for the contours of the core 25 and form the generally uniform outer surface 23. As shown in FIGS. 2 and 7, the thickness d of the outer layer 35 is measured in the radial direction generally perpendicular to the axis 22, and varies in the axial and angular directions relative to axis 22. The thickness d of the outer layer 35 is measured from an inner point 36, which is where the outer layer 35 meets the core 25, to an outer point 37, which is the outermost surface 23 of the spring wire 20. The varying thickness d of the spring wire 20 refers to the fact that none of the fiber bundles 26, or any part thereof, will be exposed at the outer surface 23 of the spring wire 20. The outer layer 35 of resin is provided along the length of the spring wire 20, thereby forming the generally uniform outer surface 23. The magnitude of the thickness d variations will depend on the contours of the underlying core 25.

For the spring wire 20 having a generally circular cross-section illustrated in FIGS. 2 and 7, the core 25 is preferably located at a central location in the spring wire 20 such that the core 25 and the spring wire 20 are generally concentric. For a spring wire 20 having a core 25 that is not centrally located at all points along the axis 22, substantial variations in the thickness d can exist in the angular direction θ about the axis 22 than existed in the spring wire 20 having the centrally located core 25.

For a spring wire 20 having a cross-sectional shape other than a circle, such as the spring wire 20 shown in FIG. 3, variations in the thickness d of the outer layer 35 will exist in the angular direction θ. There will be a greater thickness d in a corner region 42 than the thickness d in a region 44 where a radial line extending from the axis 22 forms a right angle with the outer surface 23. Any spring 10 formed from a spring wire 20 as described above falls within the scope of the present invention so long as the spring includes the generally uniform outer surface 23. This is true regardless of the cross-sectional shape of the spring wire 20, the thickness d of the outer layer 35, and the material chosen for the outer layer 35.

The generally uniform outer surface 23 advantageously provides predictable spring behavior and enhanced fatigue life. For example, the condition of the generally uniform outer surface 23 is a primary consideration in evaluating fatigue failure of a spring 10. Flaws such as seams, pits, exposed contours of the underlying twisted fiber bundles, die marks, hardening cracks, inclusions, or scratched spots may result in locations where a spring 10 will ultimately fail due to fatigue under loaded conditions.

Similarly, deflection of a spring 10 according to the present invention is predictable because of the generally uniform outer surface 23 of the spring wire 20. To illustrate the predictive nature of the spring 10, the reaction of a spring 10 subjected to a compressive load is described. When loaded, the spring wire 20 is loaded in torsion with minimal bending along a central axis 13 of the spring 10. By considering the average coil radius (R) of the spring as a lever arm, the deflection (δ) can be predicted as follows:

$$δ = \frac{64 {PR}^{3} {N}_{c}}{{GD}^{4}}$$

From this equation it is apparent that the deflection δ is inversely proportional to the fourth power of the diameter D of the spring wire 20, where P is the load, G is the modulus of rigidity, and N_{c} is the number of active coils in the spring 10. Thus, even small variations in the spring wire diameter D will result in a significant change in the deflection of the spring 10 under a compressive load.

By rearranging the above equation for the deflection of the spring 10 and setting the value of the deflection δ to one (1) unit of length, we can obtain an expression for a spring constant (also known as the spring rate or stiffness) as follows:

$$k = \frac{{GD}^{4}}{64 {N}_{c} {R}^{3}}$$

For the spring 10 made from a spring wire 20 with a generally uniform outer surface 23, this expression for the spring constant k is linear, and quantifies the force required to be exerted on the spring 10 by a load to deflect the spring 10 one (1) unit of length.

Another advantageous feature of the generally uniform outer surface 23 is the uniform distribution of shearing stress τ from a load applied to the spring 10. Due to the substantial absence of imperfections such as seams, pits in exposed contour of the underlying twisted fiber bundles, die marks, hardening cracks, inclusions, or scratched spots in the outer surface 23 and the minimal diameter variations in the generally uniform outer surface 23, shearing stress τ from an applied load is generally uniform along the length of the coiled spring wire 20, and is given as follows:

$$τ = {K}_{s} \frac{16 PR}{π {D}^{3}}$$

where Kₛ=1+0.3075(D/R). Again, this equation relates the shearing stress τ to the inverse of the third power of the diameter D of the spring wire 20, causing small variations in spring wire diameter D to bring about significant changes in the shearing stress τ. Such a stress distribution minimizes the likelihood that the spring 10 will fail due to fatigue resulting from the accumulation of shearing stress τ at one of the imperfections listed above on the outer surface 23.

There are yet other advantages of the outer surface 23, which are due in large part to the material properties of the resin selected for the outer layer 35. In addition to the obvious weight benefits derived from using a resin as opposed to a metal to fabricate a spring 10, the resin for the outer layer 35 can be selected to provide the spring with any number of desired properties. For example, a corrosion resistant resin can be selected on the basis of the intended environment of use. Additionally, properties of the spring 10 other than those resulting solely from the material selected for the outer layer 35, such as vibrational characteristics, geometric considerations, and the like, can be introduced by the method for fabricating a spring according to the present invention. This method is described in detail below.

In general, the fiber-reinforced composite springs 10 of the present invention are prepared from a spring wire 20 created by impregnating a plurality of fiber tows 26 with a resin composition to form a core 25; encasing at least a portion of said core 25 within a cavity having desired interior dimensions; and forming an outer layer 35 of resin by twisting said bundle 26 of fiber tows 26 within the cavity to remove a desired amount of said resin from the saturated core 25. In this manner, the twisting of the core 25 of fiber tows 26 removes a sufficient amount of resin to form said outer layer 35 having a thickness d that varies along the longitudinal axis 22 to form said generally uniform outer surface 23 within the interior dimensions of the cavity. The thickness d of the outer layer 35 can be controlled by adjusting the number of times the bundle 26 is twisted within the shroud 50 (FIG. 6) and by providing a cavity having desired interior dimensions. The spring wire 20 is to be wound around a mandrel 60 to form the desired helical shape of the spring 10, and the resin allowed to at least partially cure, thereby maintaining the helical shape of the spring 10. Optionally, the spring wire 20 can be removed from the cavity once the resin has cured to maintain the shape of the spring 10.

The cavity is defined by any structure such as a shroud 50, mold (not shown), and the like that confines the flow of the an amorphous, or liquid resin in a radial direction from the longitudinal axis 22. Objects such as the shroud 50 or mold can be flexible, allowing them to be wrapped around a mandrel 60 as described below, or they can be rigid structures from which the spring wire 20 must be removed prior to shaping the spring wire 20 into the spring 10. Although a number of objects can be used to define the cavity, the present invention is described in detail below as being formed with a flexible shroud 50. In an embodiment where a mold is used to encase the core 25, the resin is at least partially solidified prior to being removed from the mold. Once removed from the mold, the spring wire 20 including the core 25 and the at least partially solidified outer layer 35 are shaped into the desired spring shape. In such an embodiment, energy can be provided as needed to facilitate shaping of the core 25 and resin into the shape of a spring 10. Regardless of the object that defines the cavity, however, the interior dimensions contribute to the cross-sectional shape and size of the spring wire 20 to be formed therein, as well as other properties of the finished spring 10. For example, a generally tubular shroud 50 will have a circular cross section and a diameter sized to form a cylindrical spring wire 20 as illustrated in FIG. 2.

The fiber tows 26 can be bundled to form the core 25 by using a variety of techniques. For example, a predetermined number of tows 26 can be cut to a desired length and lightly stretched between two clamps. When bundling these tows 26, tows 26 of similar composition and diameter are to be included as part of the same core 25. As an alternative, a core 25 can include tows 26 of a variety of compositions and diameters. Further, one can mix tows 26 of different fiber materials, and otherwise bundle tows 26 as desired without departing from scope of the present invention. According to an illustrative embodiment, the bundling of fiber tows 26 can be done simply by sequentially adding tows 26 to the bundle forming the core 25. Once bundled, the fiber tows 26 are optionally twisted about the longitudinal axis 22 before being impregnated with the resin.

Various techniques exist for impregnating the bundled fiber tows 26, however, the method of the present invention is not limited to bundling the fiber tows 26 prior to impregnating them with the resin. The fiber tows 26 can be impregnated individually as they are being bundled, or at any other time. In order to clearly describe the present invention, however, an illustrative embodiment will be described herein where the fiber tows 26 are impregnated after being bundled. According to this embodiment, the step of impregnating the bundled fiber tows 26 includes submerging the bundled tows 26 into a bath of liquid resin. Other methods include pultrusion of the bundle 26 through molten thermoplastic or liquid resin, and transfer of the resin to a lightly stretched bundle of tows 26 with a brush, sponge, fabric or any other absorbent material by wiping or swiping the bundle 26 with this absorbent material sodden with resin.

To accomplish the impregnation of the core 25 of fiber tows 26, it is preferred that the resin be in the form of a liquid. An example of a suitable resin for impregnating the core 25 of bundled fiber tows 26 is a two part epoxy resin that is in the form of a liquid until the epoxy sets, at which time, the epoxy forms a durable plastic material. Where a thermoplastic resin is used, the thermoplastic can be melted by heat or dissolved or liquefied by using a solvent, for example. If a pultrusion method is used, the fiber tows 26 can simply by pulled through the molten plastic material.

The fiber tows 26 can be twisted to form the core 25 by using a variety of techniques. In one preferred embodiment, the impregnated fiber tows 26 are twisted by using a filament winding machine. These machines are known in the art and are available from the Composite Machines Company of Salt Lake City, Utah. Other sources include Pultrex of Essex, England. Preferably, these machines are computer controlled by using winding software that is known in the art. For example, winding software is available under the tradenames CADWIND™ (Material S.A.; Brussels, Belgium), and WINDING GENIE™ (Composite Machines Company; Salt Lake City, Utah).

Once the impregnated core 25 of fiber tows 26 has been optionally twisted so that it has achieved a desired tautness, diameter, and length, a shroud is placed around the core 25 to encase at least a portion of the core 25. However, the fiber tows 26 can be twisted after being placed within the shroud 50 without departing from the scope of the present invention. Since the inner surface of the shroud 50 will form the final cross-sectional shape of spring wire 20, the shroud completely encapsulates the impregnated core 25 between its terminal ends.

The core 25 of fiber tows 26 impregnated with the resin is to be encased in a shroud 50 having suitable interior dimensions to allow formation of a suitably thick outer layer 35 in a desired cross-sectional shape, thereby providing the spring wire 20 with the generally uniform outer surface 23. According to the illustrative embodiment, the fiber tows 26 are placed between lateral edge portions 53, 54 (FIG. 6) of a rectangular sheet of material that is to form a cylindrical shroud 50. With the fiber tows 26 in place, a first lateral edge portion 53 of the sheet of shroud 50 material is wrapped around the fiber tows 26 to be located adjacent to a second lateral edge portion 54 of the sheet of shroud 50 material. A generally cylindrical and flexible tube having a longitudinal slit 51 is formed as the shroud 50 when the two lateral edge portions 53, 54 of the sheet of shroud material are located adjacent to each other, the tube encasing at least a portion of the fiber tows 26. The internal diameter of the shroud 50 can be adjusted by adjusting the relative position of the first and second lateral edge portions 53, 54 of the shroud material, or shrouds with different, predetermined internal diameters can be used.

Once the first and second edge portions 53, 54 of the shroud material have been positioned to form a suitably sized diameter to encase the core 25 and allow formation of the outer layer 35, the first and second edge portions 53, 54 can be welded to each other, thereby fixing their relative positions. Welding the first and second edge portions 53, 54 of the shroud material can be accomplished by any conventional method such as by the application of thermal energy, an adhesive, and the like. Thus, according to this embodiment, the shroud 50 is formed around the resin-impregnated core 25 of fiber tows 26.

According to another embodiment, a generally cylindrical, or other geometrical shaped tube of flexible material can be provided as the shroud 50. In this case, the resin-impregnated core 25 of fiber tows 26 is inserted in an axial direction through an opening and into an interior passage defined by the tube. The core 25 is advanced in the axial direction until the desired portion of the core 25 is encased within the tubular shroud 50. At least a portion of the core 25 is to be encased within the shroud 50, meaning that terminal ends of the core 25 can extend from the shroud 50, and trimmed to a desired length following creation of the outer layer 35. It is understood, however, that the entire core 25 can also be encased within the shroud 50 and sealed therein such that the terminal ends of the core 25 and all portions therebetween will be enclosed by the outer layer 35.

Inserting the core 25 into the tubular shroud 50 as described above while the resin is in a liquefied, or other amorphous state can smear the resin and introduce imperfections in the generally uniform outer surface 23. To minimize this effect when a thermoplastic resin is employed, the thermoplastic resin can be allowed to at least partially solidify before inserting the core 25 into the shroud 50. Once the core 25 is inside the tubular shroud, the resin can be reliquefied. Thermal energy can be supplied to reliquefy the resin, or, alternatively, ultraviolet energy, vibrational energy, ultrasonic energy having a suitable frequency, or other form of energy, or any combination thereof can be used to reliquefy the thermoplastic resin within the shroud 50. An appropriate shroud material should be chosen if reliquefication of the resin inside the shroud 50 is desired to prevent damage to the shroud 50 during the reliquefication procedure.

The shroud should be flexible enough to be wound in the form of a helical spring without forming any significant kinks or creases. One embodiment of this invention employs a shroud having a circular cross-section as shown in FIG. 6. Shroud 50 may comprise a piece of flexible tubing such as polyvinylchloride or neoprene tube. In practice, the tube is severed at location 51 along its longitudinal axis. This allows the tube to be opened and placed around the twisted bundle of tows while the integrity or elasticity of the tube allows it to close around and encase the bundled fibers. Alternatively, shrouds of desired cross-sectional shape can be extruded by using the appropriate single or twin screw extruder equipped with extrusion dyes. These dyes can be manufactured to induce the longitudinal slit on the shroud thus negating the step of longitudinal slitting described above.

Once the bundled fiber tows 26 are encased within the shroud 50, the bundled tows 26 are to be twisted to remove a portion of the resin impregnated within the fiber tows 26. This twisting will decrease the diameter of the core 25 of fiber tows 26 and squeeze additional impregnated resin from the core 25. Resin removed from the core 25 will be discharged to an area between the core 25 and the inner surface of the shroud 50. As a result, outer layer 35, which comprises resin and is substantially devoid of fiber reinforcing material such as the tows 26 and their filaments 27, is formed between the twisted core 25 and the inner surface of the shroud 50. As the core 25 is continually twisted, the diameter of the core 25 will continue to decrease and the thickness d of outer layer 35 will increase. Generally, the more the core 25 is twisted within the shroud 50, the larger the ratio of outer layer thickness to core 25 diameter will be.

The thickness d of the outer layer 35 can be controlled by twisting the resin-impregnated core 25 to remove a desired amount of resin. Accordingly, twisting the resin-impregnated core 25, along with the interior dimensions of the shroud 50 ultimately determine the diameter of the spring wire 20. The final diameter of the spring wire 20 impacts properties of the spring 10 such as the magnitude of the spring constant; the vibrational properties of the spring 10, including the resonant, or natural, frequency of vibration; deflection rates; and other properties. For example, the spring constant is directly proportional to the fourth power of the spring-wire 20 diameter. As mentioned above, however, other factors can also affect the magnitude of the spring constant.

Similar to the twisting of the fiber tows 26 described above, the impregnated fiber tows 26 can be twisted within the shroud 50 by using a variety of techniques. In one preferred embodiment, the impregnated fiber tows 26 are twisted by using one of the filament winding machines described above. Although the twisting can take place at any speed, preferable rates include between 10 and 250 rpm. The winding angle may vary from 0° to 90°, and helical, circumferential, polar and nonlinear winding paths can be employed.

Once the core 25 has been twisted within the shroud 50 to achieve a desired core diameter and outer layer thickness d, the shroud 50, which encases the newly formed spring wire 20, is wrapped around a mandrel 60 as shown in FIG. 6. This step of wrapping the shrouded spring wire 20 around the mandrel 60 can be accomplished by using various techniques. For example, a filament winding machine, a lathe or similar rotational device can be used for this purpose. If a proper mandrel 60 is machined with a helical groove 62 of desired pitch that is deep enough to accommodate the shrouded spring wire 20, wrapping can also be done manually in this groove. A grooved mandrel 60, however, is not required.

The shape and size of the mandrel 60 is preselected based upon the desired shape and size of the spring 10. In order to prepare a conical spring 10, as shown in FIG. 4D, mandrel 60 would be a truncated cone, i.e., its diameter increases over its longitudinal axis 22, and therefore the resulting spring 10 will be conical. The shape of the mandrel 60 determines the shape of the spring 10 to be made such as those shown in FIG. 4. The winding pitch over this mandrel 60, i.e., the helix angle, determines the number of coils that can be placed along a predetermined spring length. This, in turn, determines the magnitude of the spring constant. The spring constant increases linearly with a decreasing number of coils. The spring coil diameter and the wire diameter also impact the spring constant. The spring constant is inversely proportional to the third power of the coil radius, and directly proportional to the fourth power of the wire diameter. Composite springs 10 of variable rate can be made by changing the winding pitch over the mandrel 60 as desired. Preferably, the shroud 50 is wrapped around the mandrel 60 in a direction opposite to the direction that the core 25 is twisted.

Once the shrouded spring wire 20 is wrapped around the mandrel 60, sufficient time should be provided for the resin to harden. Ideally, sufficient time should be provided so that the resin completely hardens. The step of hardening may take place at room temperature and atmospheric pressure. Depending on the resin employed, however, heat, an elevated pressure, or both may be required for curing the resin. For example, many epoxy resins require cure at elevated temperatures as specified by the particular epoxy resin chosen.

Once the resin has sufficiently hardened, the shroud 50, which contains the core 25 and resin, is removed from the mandrel 60. This can be accomplished by initially separating the helical shroud 50 manually from the mandrel 60, and subsequently by sliding it off the mandrel 60. In order to facilitate the removal of the shroud 50 from the mandrel 60, a release agent such as Teflon spray may be applied to the mandrel 60 before the shroud 50 is wound onto the mandrel 60.

Once the shroud 50, which contains the spring wire 20, is removed from the mandrel 60, the shroud 50 should be removed from what is now the composite spring 10. In most situations, the shroud 50 can be easily pulled away from the generally uniform outer surface 23 of the composite spring 10. In other situations, a solvent, which preferably dissolves the shroud material, can be employed. Also, it should be appreciated that in certain instances, the shroud 50 could be removed from the composite spring 10 while the composite spring 10 remains on the mandrel 60. In this situation, the core 25 should be longer than the shroud 50 with its terminal ends extending from the shroud 50. By fixing these terminal ends to the mandrel 60, the shroud 50 can simply be pulled off the composite spring 10, which can remain on the mandrel 60. The composite spring 10 is then subsequently removed by detaching and sliding it off of the mandrel 60.

In order to demonstrate the practice of the present invention, the following examples have been prepared and tested. The examples should not, however, be viewed as limiting the scope of the invention. The claims will serve to define the invention.

### General Experimentation

The filament winding machine (Composite Machines Company, Salt lake city, Utah) was the primary equipment used for our study. It is a 4-axes CMC controlled machine equipped with a 2-speed gearbox, which is capable of generating speeds up to 250 rpm. The horizontal and radial movement of the carriage, the rotating eye and the motion of the spindle (clockwise and anti-clockwise direction) constitute the four axes through which the filament winder can function.

The horizontal carriage could traverse from speeds as low as 10 mm/sec to as high as 1800 mm/sec. Objects up to 3.1 meters in length and 1.05 meters in diameter can be wound using this equipment. The winding angle varies from 0° to 90°. The real versatility of this machine is the ability to program it to generate various patterns using software such as CADWIND and WINDING GENIE with which it is equipped. Helical, circumferential, polar and even non-linear winding paths are available through this software. The features of each of the 4 axes of the filament winder as provided by the manufacturer are given in Table I.

TABLE I

| Axis | Specifications | Resolution |
|---|---|---|
| Spindle Rotation | Up to 250 rpm | 0.005°/bit |
| Horizontal Carriage | 1.78 m/s | 0.0127 mm/s |

Having arrived at the correct combination of epoxy and curing agent, the next step was to impregnate fiber tows with this matrix and wind them by using suitable techniques to fabricate springs of helical configuration. Helical springs of three different coil and wire diameters were required. This was accomplished with the use of 3 different PVC pipes of outside diameters 37.1 mm, 42.5 mm and 48.5 mm which served as the mandrel to form the coil diameter when the actual winding was performed. Three different PVC tubing of 3.18 mm, 4.76 mm, and 6.35 mm inside diameters were selected to form the spring wire diameter. By using an Xacto knife, a clean incision was made on the PVC tube to form the rectangular sheet of shroud material. Care was taken to ensure that the incision was along a straight line, which would otherwise leave a poor surface finish on the spring wire.

The procedure for the fabrication of helical springs can be broken down into three stages. First, the number of glass/carbon fiber tows that could be accommodated within the tubing had to be determined. This was done by measuring the cross-sectional thickness of a fiber tow with a micrometer and comparing it with the inner diameter of the tubing into which it is to be enclosed. This provided insight as to the number of tows that were required to fill the PVC tube completely. While a decision on the approximate number of tows was being made, the reduction in diameter due to wetting by the epoxy was also taken into consideration. The fiber tows were then attached to specially made chucks. These chucks were made with cylindrical wooden bars into which a hole was drilled along its length. Metal roller bearings were fixed on the ends of the chucks. One of the chucks was attached to the headstock (moving) and the other to the tailstock (stationary) of the filament winder.

The second stage involved preparation of the epoxy resin bath, which was done by mixing together 88 grams of Epon 815-C and 12 grams of DETA by using a mechanical stirrer. This mixture was poured into a wide base aluminum pan. Subsequently, the fibers were immersed in the thermosetting resin solution and wetted thoroughly. These wetted fibers were then mounted back on to the winder and twisted either in the clockwise or counterclockwise direction. Care was taken to see that the direction in which the fiber tows were rotated was kept the same throughout the study. In all of our experiments, the fiber tows were twisted in the clockwise direction, which results in a tightening action on the twisted tows when the helical springs in which they are encased are wound in counterclockwise direction and loaded in compression.

It was observed that after 28-30 rotations, the fiber tows were twisted taught enough that the tailstock began to rotate. It was at this point that further twisting was discontinued. In order to maintain a homogeneous fabrication technique, the number of rotations the fibers were subjected to was limited to 30. The slit PVC tube was then carefully wrapped around the impregnated core, and the first and second edge portions of the shroud material welded to each other. At this stage, the fibers were further subjected to an additional five turns within the PVC tube, which helped squeeze out the excess resin and compact the fiber tows, thus imparting a cylindrical shape to the core.

In the third stage, a PVC pipe of a specific diameter (say 37.05 mm) was mounted as the mandrel on to the winder. The diameter of the pipe determines the coil diameter of the spring to be manufactured. In order to facilitate easy removal of the cured spring, the mandrel was sprayed with a mold release agent. Special software that was solely created for winding helical springs was used to wrap the fiber bundle around the mandrel at a precise winding angle and at a predetermined pitch (80° winding angle; 10° helix angle). The coils of the spring were wound in a direction opposite to the strand direction. This not only ensures the binding between strands but also the unwinding action that may be caused due to a twisting moment can be avoided when the spring is loaded in the compressive mode. The winding angle for all springs was set to 80°, which yielded a helix angle of 10°. The ends of the wound springs were fastened by an adhesive tape or clamped with binder clips. Care was taken to ensure that the ends of the springs were as flat as possible (helical angle=0°). This facilitated the subsequent experiments involving the determination of stiffness.

The specimens were allowed to cure at 30° C. and 35% relative humidity for over 12 hours. After complete curing, the PVC tubing was carefully peeled off leaving behind the fabricated spring. The above procedure was repeated with two other mandrels of diameters 42.5 mm and 48.45 mm. In order to make helical springs of varying wire diameters, PVC tubes of differing inner diameters were used. When larger diameter tubing was used, the number of tows of glass/carbon filaments had to be increased altering the stiffness of the spring. The required number of tows to fill the appropriate PVC tubing completely is illustrated in Table II

TABLE II

| PVC | | |
|---|---|---|
| Tube (Inner Diameter) | Glass Filament Tows | Carbon Filament Tows |
| 3.1750 mm | 10 | 2.5 |
| 4.7625 mm | 22 | 5.0 |
| 6.3500 mm | 30 | 8.0 |

The same procedure was followed in order to make hybrid springs from fiber tows comprising a combination of glass and carbon filaments. For this purpose, the ratio of volume fractions of carbon to glass fiber tows had to be determined first. It was observed that the volume occupied by one tow made of carbon filaments was approximately equivalent to that occupied by 4 tows made of glass filaments. The combination of glass and carbon fiber tows that was used in the making of hybrid springs is depicted in Table III.

TABLE III

| PVC Tube (Inner Diameter) | Combination of Fibers Used |
|---|---|
| 3.1750 mm | 6 Tows of Glass Filaments + 1 Tow |
| | of Carbon Filaments |
| 4.7625 mm | 12 Tows of Glass Filaments + 2 Tows |
| | of Carbon Filaments |
| 6.3500 mm | 18 Tows of Glass Filaments + 3 Tows |
| | of Carbon Filaments |

To measure the axial stiffness constant of the springs fabricated by the above-described procedure, an in-house testing set up was devised. This simple testing method consisted of constructing a solid steel platform on top of which was a fixed cylindrical bar. The diameter of the bar was chosen to accommodate all three helical springs of different coil diameters. Two aluminum plates of 8 cm 10 cm were used as endplates during stiffness measurements. A circular hole equivalent to the diameter of the cylindrical bar was drilled in the center of the two aluminum plates. On one of the plates two small holes were drilled on either sides to facilitate the application of weights.

The helical spring having a wire diameter of 3.175 mm was placed in between these two plates and the length of the helical spring was measured with a micrometer. This initial condition is referred to as the “no-load” or unstressed condition. Precise loads ranging from 20 grams to 1000 grams were used in subsequent measurements to load the spring in compression axially. These loads were applied on either sides of the top plate and the weights used for loading were gradually increased from 20 grams to 2000 grams in increments. The corresponding displacements of the spring were measured with a micrometer. With the initial length of the spring and the subsequent displacements, the deflection that the spring underwent for specific loads was determined.

With this data, a plot of load versus deflection was made and the slope of this plot gives an estimate of the stiffness constant for the helical spring. The above procedure was carried out for a spring having 7 active turns. The same procedure was repeated by cutting off turns of the original spring to study the stiffness constants for 6, 5 and 4 active turns (coils). This method of testing was found to be ideal for determining the stiffness constant of springs with small wire diameters. Also, the procedure used was checked for consistency by subjecting the same spring to different loading patterns. The repeated values obtained under differing conditions proved the accuracy of the testing procedure that was used. For larger wire diameter springs such as 4.76 mm and 6.35-mm diameters, a similar procedure was used with an Instron 4204 tensile tester.

In order to evaluate and compare the theoretical stiffness for different composite helical springs, Young's modulus, bulk modulus, transverse stiffness and shear modulus for the composite are needed. The calculation of these parameters necessitates that the volume fractions of the fibers and epoxy be known. This was accomplished by making use of the procedure described below.

One complete coil of the fabricated spring was cut and its length was measured with a plastic string. An equal length of glass and/or carbon fibers was selected, and since the number of tows used for that particular spring was known, the amount of fibers present in the matrix could be found. The single coil was also weighed and the difference between the two above-mentioned quantities gave the amount of adhesive that was incorporated into the matrix. Since the weight and density of the materials are known, the volume fractions of the fiber and matrix could be calculated.

The shear modulus, G₂₃, values were calculated for the spring wire material based on the experimentally determined volume fraction and spring stiffness values. These values were found to increase linearly with increasing coil diameters, while the G₂₃ values showed a decreasing trend with the wire diameter.

The shear modulus of hybrid strings measured experimentally were found to be very close to what was obtained by using the rule of mixtures, which calculates the composite modulus as the addition of the contribution from individual fiber components as proportional to their volume fraction in the total volume of fibers in the composite spring.

A cross-sectional area of the fabricated helical spring was sectioned and viewed under a Scanning Electron Microscope (SEM) to determine the position and distribution of glass fibers in the epoxy matrix and also to assess the size of the epoxy layer. For this purpose, a Hitachi S-125O SEM was used along with a Polaron coating system that helped to sputter the samples. The SEM photographs confirmed that the fibers were concentrated in the center, and encased in an epoxy outer layer.

While the best mode and preferred embodiment of the invention have been set forth in accord with the Patent Statues, the scope of this invention is not limited thereto, but rather is defined by the attached claims. Thus, the scope of the invention includes all modifications and variations that may fall within the scope of the claims.

What is claimed is:

1. A fiber-reinforced composite spring comprising:
a spring wire comprising
a core that includes a plurality of fiber tows twisted about a longitudinal axis to create a contoured core surface; and
an outer layer of resin that is substantially devoid of said fiber tows, wherein
said outer layer has a thickness that varies along the longitudinal axis to form a generally uniform outer surface about the core.

2. The spring of claim 1, wherein the core is disposed within the spring wire at a generally central location.

3. The spring of claim 1, wherein said spring has a predictable rate of deformation when subjected to a load.

4. The spring of claim 1, wherein said spring wire has a generally cylindrical shape.

5. The spring of claim 4, wherein the core is generally concentric with the generally uniform outer surface such that the core is located at a substantially constant radial distance from the generally uniform outer surface for a cross-section of the spring wire taken at a point along the longitudinal axis.

6. The spring of claim 1, wherein said spring has a generally rectangular cross-section.

7. The spring of claim 6, wherein the core has a central axis that is generally coaxial with a central axis of the spring wire such that the central axis of the core is located at an approximately equal radial distance from opposing planar surfaces of the rectangular cross section of the generally uniform outer surface.

8. The spring of claim 1, wherein said fiber tows are natural fibers selected from the group consisting of jute and rayon fibers.

9. The spring of claim 1, wherein said fiber tows are synthetic fibers selected from the group consisting of glass, carbon, boron, boron, silicon carbide, aluminum oxide, quartz, alumina-silica, alumina-boria-silica, zerconia-silica, and fused silica fibers.

10. The spring of claim 1, wherein said resin is a thermoplastic resin.

11. The spring of claim 1, wherein said resin is a thermosetting resin selected from the group consisting of epoxy, bis-maleimide, polyimide, polyester, vinyl ester resins, polyether, ether ketone, polyphenylene sulfide, polyetherimide, and polyamide imide resins.

12. A fiber-reinforced composite spring formed by a process comprising the steps of:
impregnating a plurality of fiber tows with a resin;
encasing at least a portion of said core within a cavity having desired interior dimensions;
controlling a thickness of an outer layer formed by removing a portion of said resin from said impregnated fiber tows by twisting said core within the cavity to form a spring wire; and
shaping said spring wire to form a spring.

13. The spring of claim 12, wherein said step of encasing at least a portion of said core within said cavity comprises the steps of:
providing a generally planar sheet of flexible shroud material;
placing said core in contact with said sheet of shroud material;
wrapping said sheet of shroud material around said core; and
securing a first portion of said sheet of shroud material to a second portion of said sheet of shroud material to form said cavity around the core.

14. The spring of claim 12, wherein said step of impregnating said plurality of fiber tows with said resin comprises the step of:
impregnating said plurality of fiber tows with a thermoplastic resin.

15. The spring of claim 14, wherein the step of encasing at least a portion of said core within said cavity comprises the steps of:
at least partially solidifying said thermoplastic resin to minimize smearing of said resin while encasing said core;
inserting said core and said at least partially solidified thermoplastic resin into said cavity; and
exposing said thermoplastic resin within said cavity to a suitable source of energy for liquefying said at least partially solidified thermoplastic resin within said cavity.

16. The spring of claim 15, wherein said cavity is an interior passage defined by a shroud of flexible material that is to encase said spring wire.

17. The spring of claim 12, wherein said process further comprises the steps of:
at least partially solidifying said resin in the spring shape within said cavity; and
removing said spring wire from said cavity.

18. The spring of claim 17, wherein said resin is a thermosetting resin.

19. The spring of claim 18, wherein said step of at least partially solidifying said resin within said cavity includes the steps of:
wrapping said spring wire around a mandrel; and
at least initiating crosslinking of the thermosetting resin.

20. The spring of claim 12, wherein the step of shaping said spring wire to form said spring comprises wrapping said spring wire encased within said cavity around a mandrel.

21. A method for forming a fiber-reinforced composite spring, the method comprising the steps of:
forming a spring wire according to a method comprising the steps of
impregnating a plurality of fiber tows with a resin to form a core;
encasing at least a portion of said core within a cavity having suitable interior dimensions; and
forming an outer layer of resin having a variable thickness along a longitudinal axis to form a generally uniform outer surface by twisting said core within said cavity to remove a portion of said resin from said core; and
shaping said spring wire into a spring.

22. The method for forming a spring of claim 21, wherein the step of impregnating a plurality of fiber tows with a resin includes pultrusion.

23. The method for forming a spring of claim 21, wherein said resin for impregnating said plurality of fiber tows is a thermoplastic resin.

24. The method for forming a spring of claim 23, wherein the step of encasing at least a portion of said core within a cavity comprises the steps of:
at least partially solidifying said thermoplastic resin to minimize smearing of said resin while encasing said core;
inserting said core and said at least partially solidified thermoplastic resin into said cavity; and
exposing said at least partially solidified thermoplastic resin to a suitable source of energy for liquefying said at least partially solidified thermoplastic resin within said cavity.

25. The method for forming a fiber-reinforced spring of claim 21, wherein the cavity is defined by a flexible shroud having a cross-sectional shape selected from the group consisting of circular, rectangular, oblong, elliptical and triangular.

26. A method for forming a fiber-reinforced composite spring, the method comprising the steps of:
forming a spring wire according to a method comprising the steps of:
impregnating a core comprising a plurality of fiber tows with a resin;
encasing at least a portion of said core within a flexible shroud having suitable interior dimensions;
forming an outer layer of resin with a generally uniform outer surface; and
controlling a thickness of said outer layer by twisting said core of fiber tows within the shroud to remove a desired amount of resin from the core to form said generally uniform outer surface; and
shaping the spring wire into a spring.

28. A fiber-reinforced composite spring comprising:
a spring wire comprising
a core that includes a plurality of fiber tows twisted about a longitudinal axis to create a contoured core surface; and
an outer layer of resin having a generally uniform outer surface, wherein
shearing stress on said composite spring resulting from an applied load is generally constant along said longitudinal axis of said spring wire.

29. The spring according to claim 28, wherein said generally constant shearing stress along said longitudinal axis of said spring wire is inversely proportional to a diameter of said spring wire to the third power, and is given by the equation:
$$τ = {K}_{s} \frac{16 P R}{π {D}^{3}}$$
wherein Ks is 1+0.3075(D/R); P is a magnitude of a load imparted on said spring; R is an average coil radius of said spring; and D is a diameter of said spring wire.

30. The spring according to claim 28, wherein said spring wire is generally cylindrical, having a substantially constant diameter.

31. The spring according to claim 28, wherein said spring has a predictable deformation when subjected to a compressive load, said deformation being predictable from the equation:
$$δ = \frac{64 P {R}^{3} {N}_{c}}{G {D}^{4}}$$
wherein P is a magnitude of a compressive load imparted on said spring; R is an average coil radius of said spring; Nc is a number of active coils in said spring; G is a modulus of rigidity; and D is a diameter of said spring wire.
